(19) United States
(12) Patent Application Publication
(10) Pub. No.: US 2014/0153623 A1
(43) Pub. Date: Jun. 5, 2014

(54) DEVICE FOR AUTO BAUD RATE DETECTION

(71) Applicant: DINKLE ENTERPRISE CO., LTD., New Taipei City (TW)

(72) Inventor: Ching Han CHEN, New Taipei City (TW)

(73) Assignee: DINKLE ENTERPRISE CO., LTD., New Taipei City (TW)

(21) Appl. No.: 13/690,479

(22) Filed: Nov. 30, 2012

(51) Int. Cl. H04L 25/02

(52) U.S. Cl. CPC H04L 25/0262
USPC 375/224

(57) ABSTRACT

A device for auto baud rate detection includes an edge trigger, a counter, at least one register and a central processing unit. The edge trigger detects whether a potential of a transmitted signal is raising or falling. The counter is connected to the edge trigger and uses the edge trigger to count pulse widths of the transmitted signal. The register is connected to the counter and stores the pulse widths. The central processing unit is connected to the register, compares the pulse widths so as to identify a minimal pulse width, and calculates a baud rate according to the minimal pulse width by using a probability density function. Thereby, the device is advantageous for lowering hardware costs, increasing use flexibility, reducing configuration limitation and ensuring accurate baud rate detection.

### BACKGROUND OF THE INVENTION

1. Technical Field

The present invention relates to auto baud rate detection, and more particularly, to a device for auto baud rate detection applied to digital serial transmission.

2. Description of Related Art

Digital signals can be transmitted through serial transmission or parallel transmission, and serial transmission may be performed in a synchronous manner or an asynchronous manner. In the case of asynchronous serial transmission, the baud rate has to be determined by the receiving end shortly after the commencement of signal transmission so as to determine the contents of the signals transmitted.

The baud rate is currently detected through hardware, such as those devices described in U.S. Pat. No. 5,008,902, titled Automatic Baud Rate Detection, and China Pat. No. CN101626288, titled UART Device with Baud Rate Detection and Detection Setting Method Thereof. However, the prior-art approaches are disadvantage for costing highly in terms of hardware and having their circuit design limited to some certain prevailing and inflexible constructions and/or frequencies, causing their applications to be inflexible.

On the other hand, baud rate detection has also been performed in a software-based manner, where the baud rate is determined during program execution through use of a lookup table, such as that described in U.S. Pat. No. 7,333,536, titled System and Method for Auto Baud Rate Detection in Asynchronous Serial Communication. This approach, however, is disadvantageous because in the event that the frequency to be detected has deviation, baud rate detection can be compromised, leading to misreading of the transmitted signals.

Hence, addressing the problems and shortcoming of the prior-art devices has been a pressing need for the inventor and those manufacturers working in the related fields to meet.

### BRIEF SUMMARY OF THE INVENTION

In view of the above-mentioned problems of the prior art, the inventor has conducted extensive research, evaluation and consideration, and used his years of experience in the art to repeatedly perform trials and modifications, thereby accomplishing the present invention.

One objective of the present invention is to provide a device for auto baud rate detection that costs less in terms of hardware, frees its application from the limitation of construction, and determines baud rates accurately.

To this end, the disclosed device for auto baud rate detection comprises:

an edge trigger, detecting whether a potential of a transmitted signal is rising or falling;

a counter being connected to the edge trigger and using the edge trigger to count pulse widths of the transmitted signal;

at least one register being connected to the counter and storing the pulse widths; and

a central processing unit being connected to the register, comparing the pulse widths so as to identify a minimal pulse width, and calculating a baud rate according to the minimal pulse width by using a probability density function.

In one preferred embodiment, the transmitted signal is a digitally transmitted signal.

In one preferred embodiment, the probability density function is Gaussian Probability Density Function.

In one preferred embodiment, the probability density function preloaded with a plurality of baud rate parameters.

With the foregoing construction, during signal transmission, the edge trigger detects whether the potential of the transmitted signal is rising or falling, so as to enable the counter to get and store pulse widths of the transmitted signal into the register. When there is an appropriate number of the pulse widths stored, the central processing unit compares these pulse widths to identify a minimal pulse width, and uses a probability density function to calculate a baud rate according to the minimal pulse width.

Thus, opposite to the existing devices, which require high hardware costs, are limited to inflexible use and tend to determines baud rates incorrectly, the disclosed device for auto baud rate detection is advantageous for its low costs, flexible use and accurate detection.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a block diagram illustrating the operation of one preferred embodiment of the present invention;

FIG. 2 is another block diagram illustrating the construction of the preferred embodiment of the present invention;

FIG. 3 is a flowchart of the preferred embodiment of the present invention; and

FIG. 4 is a probability density function plot according to the preferred embodiment of the present invention, a plurality of baud rates look-up table are preloaded according to Gaussian Probability Density Function.

### DETAILED DESCRIPTION OF THE INVENTION

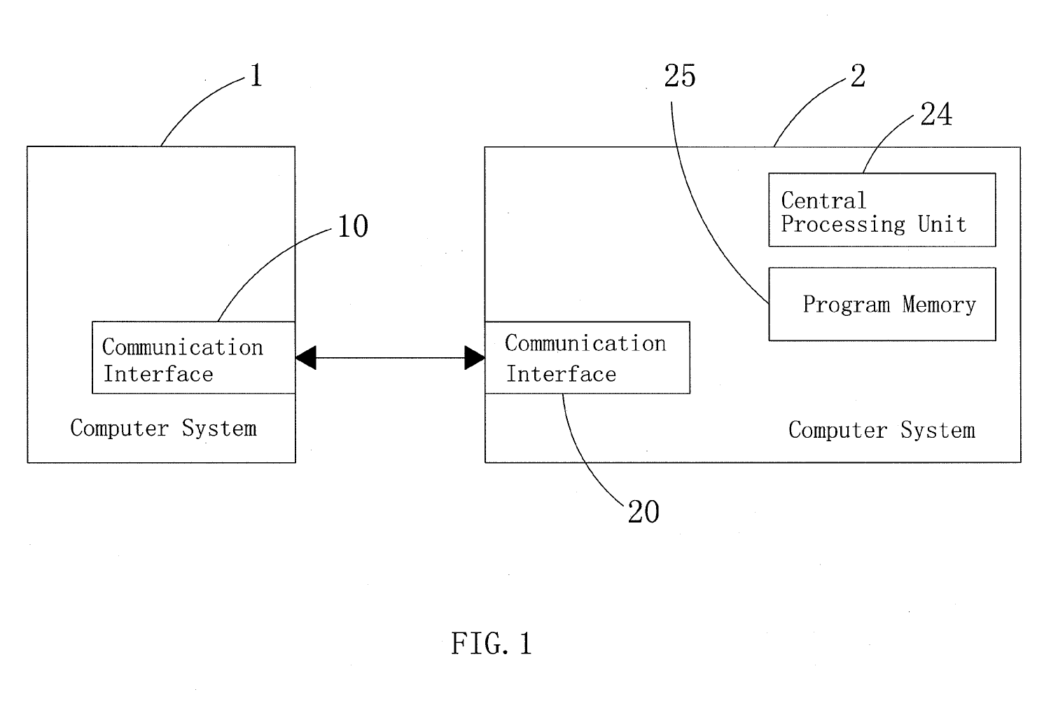

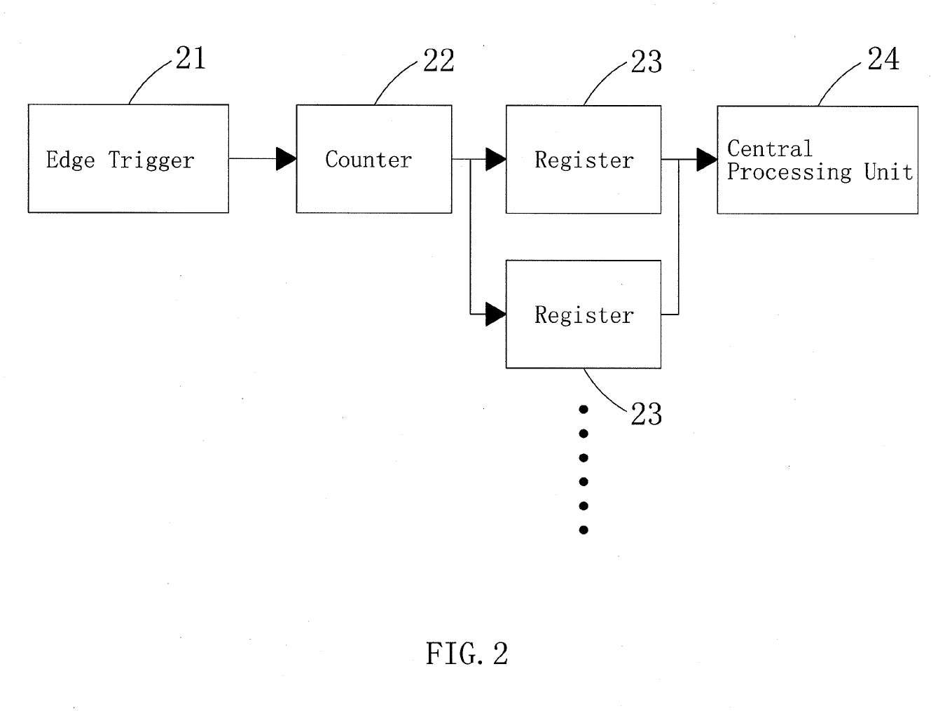

FIG. 1 and FIG. 2 are two block diagrams illustrating one preferred embodiment of the present invention. As shown, according to the present invention, a device for auto baud rate detection comprises: an edge trigger 21, a counter 22, at least one register 23 and a central processing unit 24.

The edge trigger 21 is configured to detect whether a potential of a transmitted signal is rising or falling. In the present embodiment, the transmitted signal is a digitally transmitted signal, and the detection is applied to an input port of a receiving end of the edge trigger associated with the transmitted signal. A reference frequency is used to calculate the width of each byte of the transmitted signal. The functions of such an edge triggering are extensively provided in various receiving blocks. For example, the input ports at embedded microprocessors, at general input/output devices, at UARTs, at DMA controllers all support the referred functions. Either a rising edge trigger or a falling edge trigger can be used in the present invention as long as it is recognizable to the associated computer system, microprocessor or similar device.

The counter 22 is connected to the edge trigger 21 and uses the edge trigger 21 to calculate pulse widths of the transmitted signal in the period between the first edge triggering event and the second edge triggering it notices. Preferably, a central processing unit (CPU) uses its main routine or sub-routine to calculate how many clocks the reference frequency has elapsed. After one or more bytes are received, the minimal number of the clocks can be determined as one cycle of the baud rate.

The reference frequency may be an internal frequency of an embedded microprocessor or of a computer system or of a counter built in a receiving system, or may be a multiple of such an internal frequency. Alternatively, the reference frequency may be a frequency used by the central processing unit for program execution. The reference frequency has to be higher than the baud rate of the transmitted signal under detection, and generally it is three times higher than the baud rate. The higher the reference frequency is, the more accurate of the detection is. In the prior art, the reference frequency as an important basis must be very precise and steady, so the cost is correspondingly high.

The register 23 is connected to the counter 22 for storing the pulse widths, and may be realized by any components capable of data storage. As shown in FIG. 2, two registers 23 are provided. However, people of ordinary skills in the art would appreciate that more registers can be used.

The central processing unit 24 is connected to the register 23 for comparing the pulse widths so as to identify a minimal pulse width, and calculating a baud rate according to the minimal pulse width by using a probability density function. In the present invention, the probability density function may be Gaussian Probability Density Function. Alternatively, the probability density function may be provided by using statistical analysis for normal distribution, or other functionally similar statistical approaches for probability density. The probability density function may be expressed as:

$$f ( t ) {=}^{Δ} \frac{1}{\sqrt{2 π {σ}^{2}}} {e}^{- \frac{{( i - μ )}^{2}}{2 {σ}^{2}}}$$

In the probability density function, a plurality of baud rate parameters are preloaded. With the parameters, the function can rapidly determine the most possible baud rate, and thus the accuracy of the reference frequency is not so strictly required, so the overall cost can be reduced without compromising the efficiency of baud rate detection. The present invention is suitable for high-end computer systems, while it is also applicable to low-end microprocessors and communication systems as well.

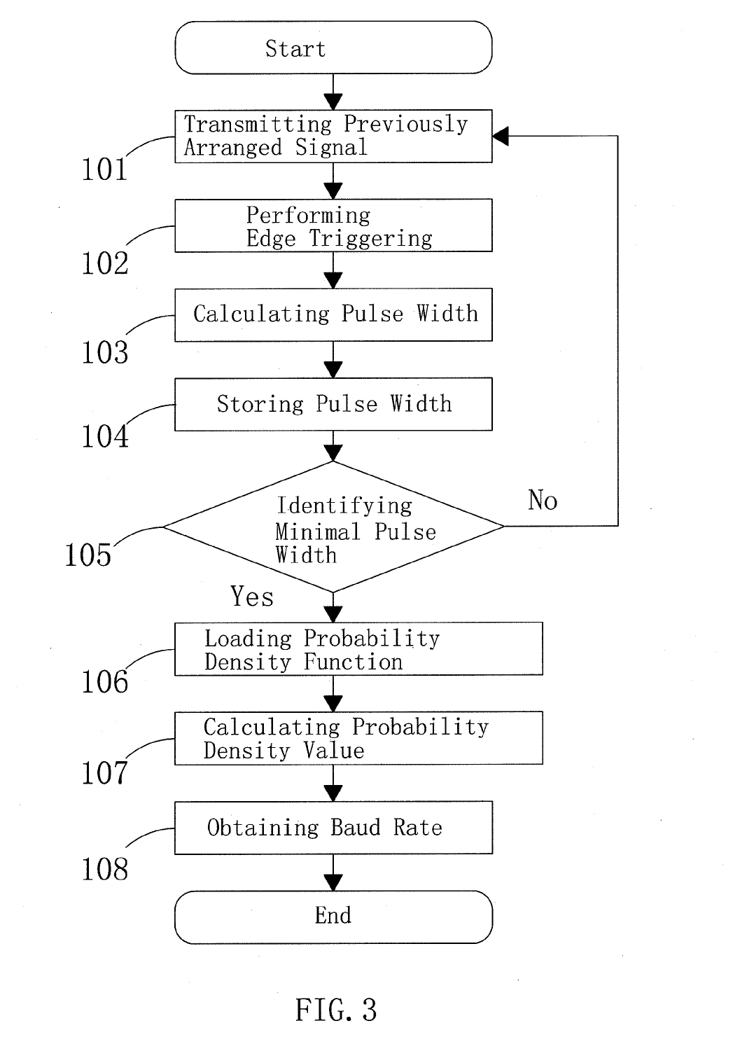

Based on the configuration of the present invention given above, the following description will be directed to the operation of the present invention. Referring to FIG. 3, the operation of the present invention includes:

(101) transmitting a previously arranged signal;

(102) performing edge triggering;

(103) calculating pulse widths;

(104) storing the pulse widths;

(105) identifying a minimal pulse width;

(106) loading a probability density function;

(107) calculating values of probability density; and

(108) obtaining a baud rate. For example, referring to FIG. 1, the computer system 1 transmits a communication signal through a communication interface 10 to a communication interface 20 of another computer system 2. The control program of the computer system 2 is stored in a program memory 25 and is accessed and executed by a central processing unit 24. Therein, baud rate detection is determined by executing the program stored in the program memory 25.

Referring to FIG. 2, the computer system 1 starts to transmit a previously arranged digital signal. Where there is such a previously arranged digital signal, the time required by baud rate detection can be reduced. Otherwise, the receiving end has to receive more bytes before becoming capable of determining the baud rate. However, the previously arranged digital signal is not required in the present invention.

When arriving at the computer system 2, the transmitted signal typically shows a falling potential change where the potential drops to a low level from a high level, or a rising potential change where the potential increases to a high level from a low level. In response to the falling or rising potential change, the computer system 2 enters an interrupt process, where the edge trigger 21 starts to perform edge triggering. Following the beginning of the interrupt process, the counter 22 starts to count using the reference frequency, and stops counting when it receives another edge triggering event that is identical to the former one in terms of falling or rising. In practical implementation, counting may be accomplished in various ways according to the hardware or software in use. For example, an integrated counter, a sub-routine, or an external counting circuit may be used for this purpose.

When the first counting activity ends, the obtained value is registered at a first location in some certain area of the register 23. Then after the second counting activity is performed and finished, the width of the second pulse as counted is registered at a second location in the register 23. When repeated to a predetermined number of rounds, counting is no longer performed, and the process enters the next step.

After several rounds of counting, a number of pulse widths are collected. The central processing unit 24 then identifies the minimal one among them. For identifying the minimal pulse width, there are many feasible ways known in practice, and the detailed explanations thereto are omitted herein.

In an alternative way to identify the minimal pulse width, the value obtained in a counting round is stored in the register 23. When a second value is generated after another counting round, the second value is compared with the one stored previously in the register 23. If the second value is smaller than that existing in the register 23, it is stored into the register 23 to replace the one stored previously in the register 23. Then if the value stored in the register 23 remains there for several more counting rounds, this value is identified as the minimal pulse width.

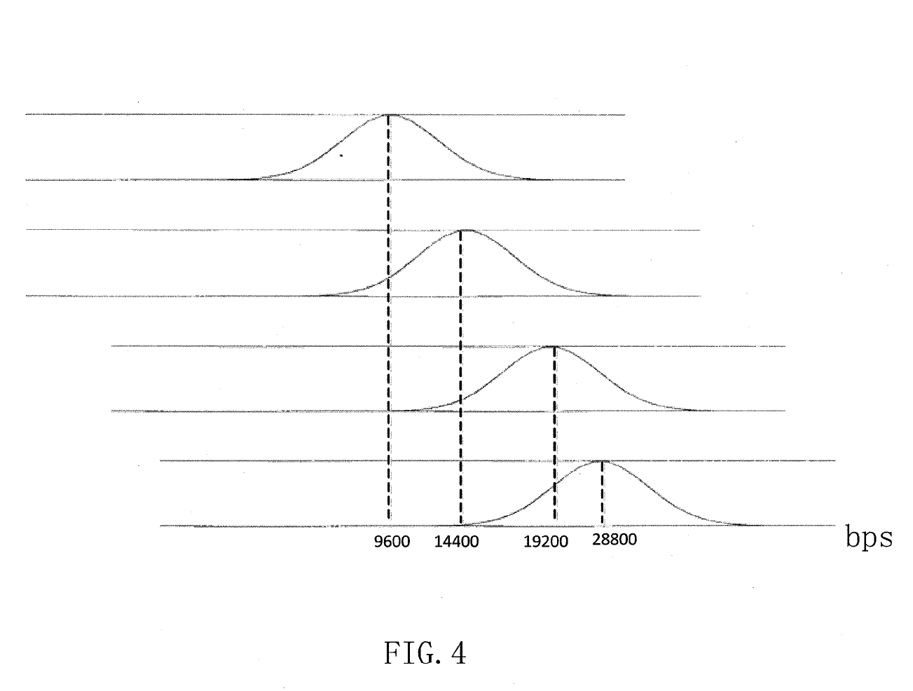

After the minimal pulse width is identified, the central processing unit 24 applies Gaussian Probability Density Function to the progress under execution. The parameters of the function are predefined baud rates, and the baud rate parameters are set as the mean of the function. The value of the minimal pulse width is then applied to every probability density function, and the value corresponding to each probability density is obtained. The probability density function having the greatest probability density is the baud rate. FIG. 4 is a Gaussian probability density function plot according to the preferred embodiment of the present invention. As shown, a plurality of baud rate parameters may be preloaded, such as those baud rates of 9600 bps (bit per second), 14400 bps, 19200 bps and 28800 bps as shown in the plot.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A device for auto baud rate detection, comprising:
an edge trigger detecting whether a potential of a transmitted signal is raising or falling;
a counter being connected to the edge trigger and using the edge trigger to count pulse widths of the transmitted signal;
at least one register being connected to the counter and storing the pulse widths; and
a central processing unit being connected to the register, comparing the pulse widths so as to identify a minimal pulse width, and calculating a baud rate according to the minimal pulse width by using a probability density function.

2. The device of claim 1, wherein the transmitted signal is a digitally transmitted signal.

3. The device of claim 1, wherein the probability density function is Gaussian Probability Density Function.

4. The device of claim 1, wherein the probability density function is preloaded with a plurality of baud rate parameters.
